(19) United States
(12) Patent Application Publication
(10) Pub. No.: US 2025/0390812 A1
(43) Pub. Date: Dec. 25, 2025

(54) MILITARY PERSONNEL MANAGEMENT SYSTEM

(71) Applicant: Permuta Technologies, Inc., Vienna, VA (US)

(72) Inventor: Benjamin Scott Dobbins, Snellville, GA (US)

(21) Appl. No.: 18/752,023

(22) Filed: Jun. 24, 2024

(51) Int. Cl. G06Q 10/0631; G06Q 50/26

(52) U.S. Cl. CPC G06Q 10/063112; G06Q 50/265

(57) ABSTRACT

A computing system generates a personnel model using records from a plurality of distinct databases. The records describe a plurality of individuals. The records further describe, for each individual, one or more attributes that are associated with the individual and relate to a suitability of the individual to a military operational assignment. The computing system determines, for each of the individuals, the suitability of the individual to the military operational assignment based on a plurality of suitability criteria and the one or more attributes associated with the individual. The computing system ranks the individuals in suitability order and outputs a natural language explanation of how an attribute influenced the ranking of an individual.

### TECHNICAL FIELD

The present disclosure generally relates to the technical field of military personnel management and, more particularly, relates to the use of machine learning and natural language generation to enhance personnel management use cases.

### BACKGROUND

Military personnel management is extremely difficult due to complex requirements, especially at senior levels. To perform in high-ranked positions, personnel often require decades of specialized training and experience in a wide variety of skills. Correspondingly, the ability to conduct long-term personnel planning for such critical personnel, who are entrusted with extraordinary responsibility implicating often innumerable lives, is an enormous task.

Traditionally, long-term personnel planning for military personnel is often conducted by senior officers who manually review personnel files, conduct interviews, and make plans based on subjective observations and understandings of the needs of the organization. These officers are typically relied upon heavily to discern trends from a variety of potentially sensitive documents spanning decades of service to select from a potentially massive pool of candidates that will remain in service for years to come. These senior officers are typically in short supply, have limited resources, and serve a broad range of needs, in matters of substantial import.

### BRIEF SUMMARY

Embodiments of the present disclosure generally relate to a computing system that provides a natural language explanation of one or more factors that may influence decision-making with respect to selection of a candidate for a military operational assignment. According to particular embodiments, the computing system generates a personnel model for numerous candidates using records from a wide variety of sources. These records include information about the candidates that may weigh favorably or unfavorably toward an individual's suitability for an assignment. The assignment may be associated with one or more assignment criteria that may be compared against the information obtained about the candidates so that the relative suitability of the candidates may be determined. Once the relative suitability of the candidates is determined, natural language generation may be applied to describe how one or more factors may influence (or have influenced) a given military personnel management decision.

Particular embodiments include a method implemented by a computing system. The method comprises generating a personnel model using records from a plurality of distinct databases. The records describe a plurality of individuals. The records further describe, for each individual, one or more attributes that are associated with the individual and relate to a suitability of the individual to a military operational assignment. The method further comprises determining, for each of the individuals, the suitability of the individual to the military operational assignment based on a plurality of suitability criteria and the one or more attributes associated with the individual. The method further comprises ranking the individuals in suitability order. The method further comprises outputting a natural language explanation of how an attribute influenced the ranking of an individual.

In some embodiments, the natural language explanation comprises an indication that the attribute positively or negatively influenced the ranking of the candidate due to the candidate either being associated or unassociated with the candidate attribute.

In some embodiments, determining the suitability for each of the individuals is responsive to receiving user input that identifies the suitability criteria.

In some embodiments, determining the suitability for each of the individuals is responsive to a change in personnel already assigned to the military operational assignment.

In some embodiments, the method further comprises outputting a further natural language explanation of one or more actions available to the individual that would improve the ranking upon completion of the one or more actions.

In some embodiments, the method further comprises determining a team of the individuals that are collectively best suited to the military operational assignment based on the suitability criteria and the attributes associated with the individuals of the team. In some such embodiments, the method further comprises outputting an indication of whether the individual is on the team of the individuals best suited to the military operational assignment.

In some embodiments, the method further comprises receiving, from a user, a natural language question that asks for the natural language explanation.

In some embodiments, the method further comprises receiving, from a user, a natural language question asking for a list of individuals suitable for the assignment. Determining the suitability of at least one of the individuals is responsive to receiving the natural language question. The method further comprises outputting at least part of the ranking in response to the natural language question.

In some embodiments, the method further comprises identifying one or more unsuitable individuals that do not meet the suitability criteria and, in response, omitting the unsuitable individuals from the ranking.

In some embodiments, the suitability criteria comprises a plurality of user-selected attributes. The method further comprises determining a non-user-selected attribute based on the plurality of user-selected attributes. The method further comprises ranking the individuals comprises ranking a first individual associated with the non-user-selected attribute higher than a second individual not associated with the non-user-selected attribute.

Other embodiments are include a computing system comprising processing circuitry and memory circuitry. The memory circuitry stores instructions executable by the processing circuitry whereby the computing system is configured to generate a personnel model using records from a plurality of distinct databases. The records describe a plurality of individuals. The records further describe, for each individual, one or more attributes that are associated with the individual and relate to a suitability of the individual in performing a military operational assignment. The computing system is further configured to determine, for each of the individuals, the suitability of the individual to the military operational assignment based on a plurality of suitability criteria and the one or more attributes associated with the individual. The computing system is further configured to rank the individuals in suitability order. The computing system is further configured to output a natural language explanation of how an attribute influenced the ranking of an individual.

In some embodiments, the computing system is further configured to perform any of the methods described above.

Yet other embodiments include a non-transitory computer readable medium storing a computer program that, when run on processing circuitry of a programmable computing system, causes the computing system to generate a personnel model using records from a plurality of distinct databases. The records describe a plurality of individuals. The records further describe, for each individual, one or more attributes that are associated with the individual and relate to a suitability of the individual to a military operational assignment. The computing system is further caused to determine, for each of the individuals, the suitability of the individual to the military operational assignment based on a plurality of suitability criteria and the one or more attributes associated with the individual. The computing system is further caused to rank the individuals in suitability order. The computing system is further caused to output a natural language explanation of how an attribute influenced the ranking of an individual

In some embodiments, the computing system is further caused to perform any of the methods described above.

Of course, those skilled in the art will appreciate that the present embodiments are not limited to the above contexts or examples and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a schematic diagram illustrating an example user interface, according to one or more embodiments of the present disclosure.

FIG. 2 is a schematic block diagram illustrating an example software architecture, according to one or more embodiments of the present disclosure.

FIG. 3 is a flow diagram illustrating an example workflow, according to one or more embodiments of the present disclosure.

FIG. 4 is a flow diagram illustrating an example method performed by a computing system, according to one or more embodiments of the present disclosure.

FIG. 5 is a schematic block diagram illustrating an example computing system, according to one or more embodiments of the present disclosure.

### DETAILED DESCRIPTION

Traditional methods of military personnel management rely heavily upon the subjective judgment of a scarce number of highly trusted, highly qualified decision-makers. Because the number of leaders who are qualified, authorized, and reliable to perform such judgments is often highly constrained, making a well-considered decision is often exhaustingly time consuming. Unfortunately, rushing these decisions often has a potential to do far more harm than good, as the consequences of these decisions can not only have implications on the military, but also on civilian populations around the world.

The reasons for making certain personnel decisions are often not communicated to those affected, particularly for decisions relating to junior positions. Indeed, traditional methods often neglect to enlighten individuals who are not selected for a particular assignment, position, or training opportunity as to why they were passed over. This lack of feedback deprives individuals of the opportunity to pursue professional development options that would lead to better military career outcomes in the future. As a result, the military may be deprived of the highest and best use of its personnel.

The lack of communication and control over career trajectory is also a significant cause of military retention issues. Increasingly, many individuals will refrain from extending their military service or retire in lieu of accepting an undesirable position that is imposed upon them without explanation. Although a career counselor can sometimes improve outcomes by bridging this gap, such counselors often lack the experience, institutional insights, and possibly even military clearance, to fully appreciate why a particular personnel decision was made.

Indeed, there are various systems across the Department of Defense for tracking manpower and organizational structure. However, these systems require special access, are often disjoint and only include a portion of the data required for a comprehensive personnel analysis. Accordingly, even a counselor who has access to these systems is often unlikely to derive significant insights into why a personnel decision was made or will be made.

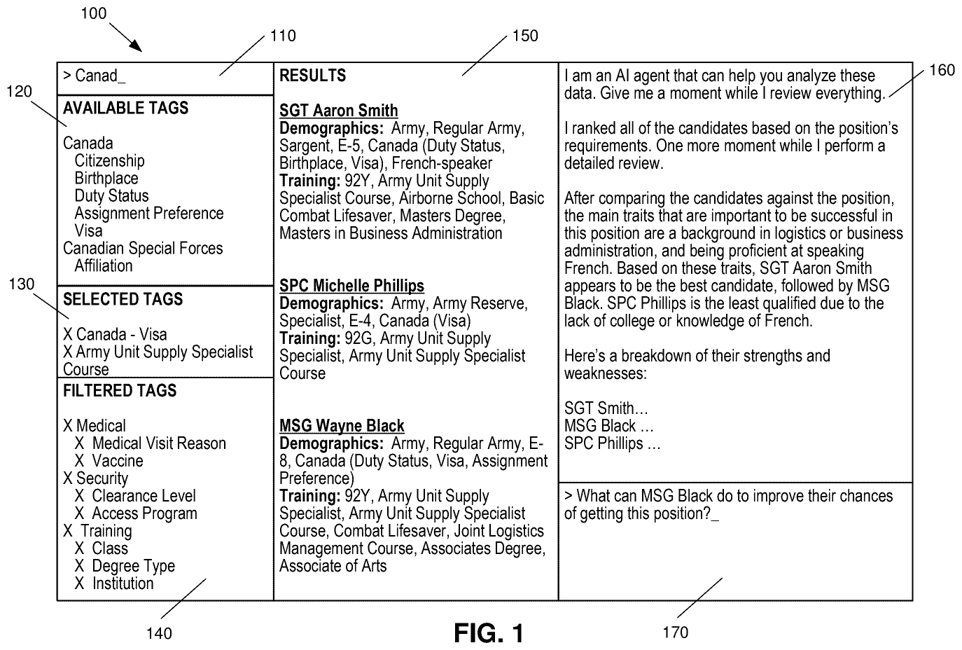

Embodiments of the present disclosure are directed to a computing system that overcomes one or more of the shortcomings in traditional methods described above. FIG. 1 is an example user interface 100 generated by such a computing system. The user interface 100 comprises a plurality of display sections. As will be described in greater detail below, sections 160 and 170 provide natural language interactivity between the computing system and a user in performing military personnel management analysis. Results section 150 provides details regarding individuals of varying degrees of suitability for a military operational assignment. Sections 110, 120, 130, and 140 allow a user to specify suitability criteria for a given assignment.

The computing system uses a personnel model that includes information about a plurality of individuals. The individuals represented in the personnel model are associated with a plurality of attributes (also referred to herein as “tags” or “labels”). These attributes may have different degrees of relevance to a given assignment.

For example, if an individual is associated with a “marksman” tag, that individual may tend to be more suitable for assignments that emphasize weapon training. In contrast, if an individual is associated with the “chaplain” tag, that individual may tend to be less suitable for assignments that emphasize weapon training. Other attributes may have no bearing on the suitability of an individual for an assignment. For example, if an individual is associated with the “AssociatesDegree” tag, the suitability of the individual may be neither more nor less suited for assignments that emphasize weapon training.

To identify attributes of relevance to the assignment, the user interface 100 comprises an attribute search section 110 through which a user can locate tags that are relevant to a given assignment. In the example of FIG. 1, a user has input the partial string “Canad” into the attribute search section 110. In response, the computing system provides, in an available tags section 120, a list of attributes that are represented in the personnel model. The user may use the available tags section 120 to select one or more attributes for the computing system to use as criteria in judging the suitability of individuals for the assignment.

In the example of FIG. 1, the user has selected the “Canada-Visa” and “Army Unit Supply Specialist Course” attributes as suitability criteria for the assignment, as shown in the selected tags section 130. In response, the computing system may filter one or more individuals that are not associated with the selected tags from being considered for the assignment; e.g., individuals who do not have a Canadian visa and individuals who have not passed the Army Unit Supply Specialist Course.

Individuals that have not been filtered out may be associated with one or more attributes that were not selected by the user as suitability criteria. To aid the user in selecting additional suitability criteria, the computing system may list these unselected tags in the filtered tags section 140. Selecting a tag from the filtered tags section 140 adds the tag to the tags listed in the selected tag section 130 and may result in the filtered tag section 140 being updated, e.g., if one or more individuals are filtered out as a result of the additional suitability criteria.

Individuals that meet the suitability criteria are listed in the results section 150. The attributes associated with each individual may be listed in the results section 150 as well. As shown in the example of FIG. 1, SGT Aaron Smith, SPC Michelle Phillips, and MSG Wayne Black each meet the suitability criteria selected by the user.

The computing system may evaluate the suitability criteria and/or the attributes associated with the filtered individuals to determine one or more further attributes that would make one of the filtered individuals more or less suitable than the others. As shown in natural language output section 160, in this example, the computing system determined, based on the user's selection of a Canadian visa and Army Unit Supply Specialist Course as suitability criteria, that other attributes reflecting that an individual has proficiency in French and/or a background in logistics or business administration would tend to make an individual more suitable for the assignment. Additionally, the computing system ranked individuals associated with the 92Y Military Occupation Code (MOS) (identifying SGT Smith and MSG Black as Unit Supply Specialists) over the individual associated with the 92G MOS (identifying SPC Phillips as a Culinary Specialist).

Based on the suitability criteria specified by the user, the additional attributes determined by the computing system, and/or the attributes associated with the individuals in the personnel model, the computing system ranks the individuals in suitability order and outputs a natural language explanation of at least part of the ranking. In this example, SGT Smith is determined to be most suitable because SGT Smith not only meets the user-specified suitability criteria but is also associated with the additional attributes determined by the computing system as advantageous. In contrast, SPC Phillips is listed as the least qualified because while she may meet the suitability criteria, she is not associated with any of the system-determined additional attributes.

Also, as shown, the computing system may provide further insights into the ranking. For example, the computing system may provide a natural language explanation of how one or more attributes influenced the ranking of one or more the ranked individuals. For example, the computing system may indicate that the 92Y MOS positively influenced SGT Smith and MSG Blacks rankings. Additionally or alternatively, the computing system may indicate that SPC Phillips' lack of a 92Y MOS negatively influenced her ranking.

The user may also interact with the computing system through natural language using natural language input section 170. In this example, the user inputs a natural language query asking what MSG Black can do to improve his suitability for the assignment. In response, the computing device may recommend that the specified individual take action that cause their records to become associated with one or more advantageous attributes. In the context of this example, the computing system may recommend that MSG Black learn French and pursue a Masters in Business Administration (MBA) because, when these factors are combined with MSG Black's higher military rank and paygrade relative to SGT Smith and MSG Black's Canadian assignment preference, the computing system would rank MSG Black higher than SGT Smith.

The computing system 250 may support a wide variety of natural language queries. For example, the computing system 250 may additionally or alternatively support a question asking for one or more of the following:
one or more individuals that are suitable for an assignment;
career planning advice for a given individual;
an explanation regarding the suitability and/or ranking of one or more individuals;
a description of a hypothetical ideal candidate;
training that an ideal candidate would have; and/or
details regarding the strengths and weaknesses of suitable candidates.

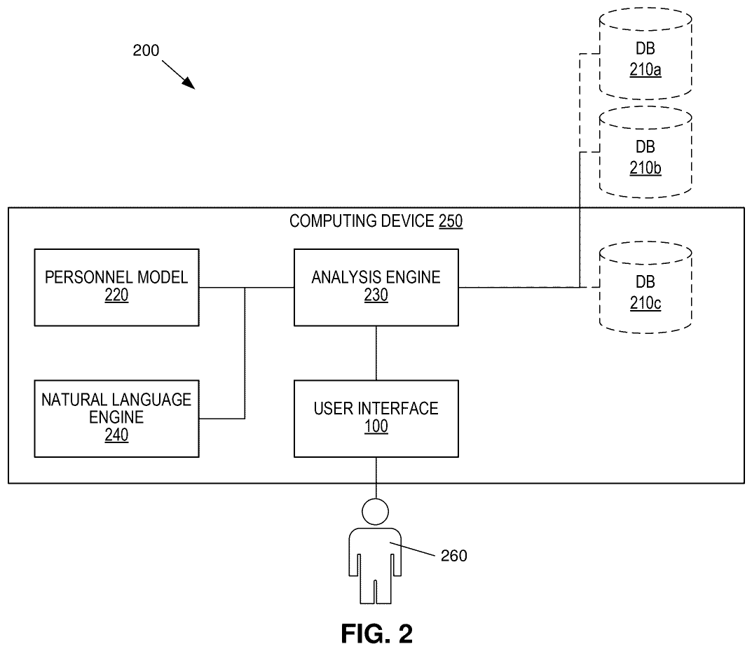

FIG. 2 is a schematic block diagram illustrating an example software architecture 200 used by a computing system 250 to perform one or more embodiments of the present disclosure. The software architecture 200 comprises a user interface 100, a personnel model 220, an analysis engine 230, a natural language engine 240, and one or more databases 210.

The one or more databases 210 store records describing a plurality of individuals. The databases 210 also describe attributes associated with the individuals. For a given military operational assignment, each attribute associated with an individual may relate to the suitability of the individual in performing a military operational assignment. For example, when a first attribute is associated with an individual, it may indicate that the individual is highly suited for the assignment. In contrast, when a second attribute is associated with an individual, it may indicate that the individual is less suited for the assignment (e.g., only moderately suited, not suited, entirely unqualified, etc.). Other attributes may bear no relevance at all to the assignment and, therefore, may have no influence on the suitability rankings performed by the computing system for the assignment.

The one or more databases 210 may be distinct from each other. For example, a first database 210a may be a medical records database whereas a second database 210b may be a military training database. Each database 210 may reside on a respective computing platform, including the computing system 250 itself, as shown by database 210c. The computing system 250 may access the databases 210 on other platforms, e.g., via a network.

The analysis engine 230 may obtain the records describing the individuals from the one or more databases 210 and use them to generate the personnel model 220, e.g., using machine learning techniques. In some examples, one or more records are labeled such that the analysis engine 230 is able to use those records as training data for the personnel model 220. Based on this training data, the analysis engine may subsequently label one or more other unlabeled records that bear similarity to the training data, e.g., using supervised learning techniques. In other examples, one or more the records may be unlabeled and the analysis engine 230 may use unsupervised learning techniques to identify clusters of like records and apply generated labels to the clusters.

The personnel model 220 stores labeled data that represent the individuals and their associated attributes. The analysis engine 230 may use this labeled data to determine the extent to which an individual is suitable for a military operational assignment and rank them accordingly.

To determine which of the attributes are relevant to the assignment, the analysis engine 230 may obtain suitability criteria from the user 260, e.g., via the user interface 100. In this regard, the analysis engine 230 may use a natural language engine 240 to provide the user 260 with natural language that articulates its findings. Correspondingly, the analysis engine 230 may use the natural language engine 240 to convert natural language provided by the user 260 into a personnel management query. The analysis engine 230 may then use the personnel model to generate an answer to the query. The analysis engine 230 may then convert the answer into natural language using the natural language engine 240 so that the computing device 250 may respond to the user 260. In this way, the computing system 250 may engage conversationally with the user 260, e.g., via the user interface 100 as described above.

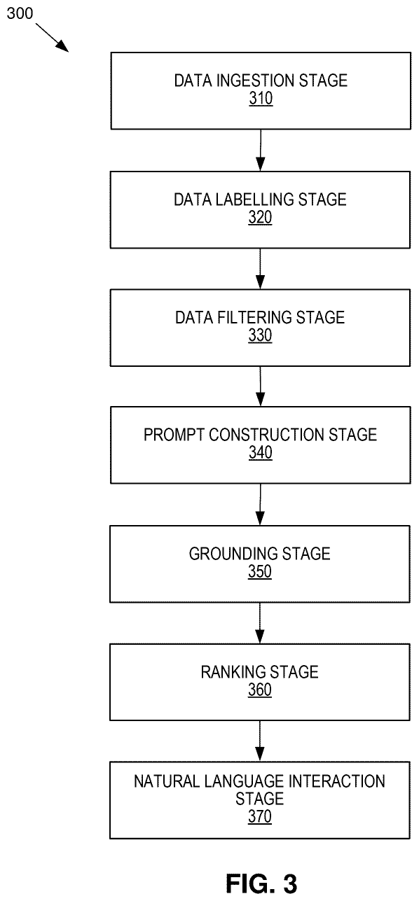

FIG. 3 is a schematic block diagram of an example workflow 300, performed by the computing system 250, according to one or more embodiments of the present disclosure. The workflow 300 comprises a plurality of processing stages. The processing stages include a data ingestion stage 310, a data labelling stage 320, a data filtering stage 330, a prompt construction stage 340, a grounding stage 350, a ranking stage 360, and a natural language interaction stage 370.

In this example workflow 300, the processing stages are performed sequentially. However, other examples may involve backtracking to previous processing stages, skipping processing stages, or performing stages in a different order.

At the data ingestion stage 310, the computing system 250 integrates data from multiple databases 210, e.g., to unify reporting across organizations. Specific data that resulted from human decisions may be treated as expert knowledge, thereby enhancing the computing system's understanding and analysis capabilities.

At the data labeling stage 320, the computing system 250 may automatically label certain data and/or update one or more labels. The labels may be stored in a centralized location (e.g., as part of the personnel model 220), so that they can be easily queried. A user 260 may then be provided with an opportunity to filter the data at the data filtering stage 330, e.g., by providing appropriate input via the user interface 100. For example, the user 260 may indicate one or more of the labels to specify suitability criteria for the assignment.

Additionally or alternatively, the user 260 may filter the data by indicating a change in personnel already assigned to the assignment. Based on the change the computing system may identify one or more suitability criteria with which to filter the data. For example, by indicating that SGT Smith has been unassigned, the computing system may identify other individuals that have similar capabilities to SGT Smith as being suitable for the assignment (e.g., by identifying MSG Black). In another example, by indicating that SGT Smith has been assigned, the computing system may reduce the ranking of MSG Black (or omit MSG Black from the ranking entirely).

The computing device 250 controls which data are included in its suitability analysis based on the suitability criteria provided by the user 260. At the prompt construction stage 340, the labels of such data may be grouped by domain (e.g., demographics and training, as shown in FIG. 1) and constructed into a prompt designed to guide the natural language engine 240 (e.g., as shown in the natural language output section 160 in FIG. 1). For example, the results shown in the results section 150 may be identified based on the selections provided by the user as shown in the selected tags section 130, and the grouped labels shown in the results section 150 may be used as input used by the natural language engine 240 to produce the natural language shown in the natural language output section 160.

Then, at the grounding stage 350, the prompt is passed to the natural language engine 240 so to establish, for the analysis engine 230, a foundation for subsequent natural language interactions and an understanding of the data that is within scope for subsequent analysis.

At the ranking stage 360, the analysis engine 230 may apply the prompt to the personnel model 220 to isolate a subset of suitable individuals represented therein from the larger dataset. To isolate suitable individuals from unsuitable (or less suitable) individuals, each of the individuals may be rated based on the attributes they are associated with, the suitability criteria, and/or one or more additional criteria identified by the computing system 250. This process of filtering more suitable individuals from less suitable individuals may proceed iteratively until less than a threshold number of individuals that represent the best assignment candidates remain.

Once a sufficiently small set of individuals is identified, the natural language engine 240 may be invoked again at the natural language interaction stage 370 to provide the user 260 with a ranking of the identified individuals. The user 260 may then interact with the computing system 250, e.g., to modify the suitability criteria, review the ranked individuals in greater detail, compare the ranked individuals, and the like.

It should be noted that interactions with the user 260 may cause the computing device 250 to revisit one or more stages of the workflow 200. For example, a modification of the suitability criteria may cause the computing system 250 to return to the data filtering stage 330. As another example, the user 260 may modify one or more records in the database(s) 210. In order to capture the change, the computing system 250 may return to the data ingestion stage 310, update one or more labels at the data labelling stage 320, and so on.

Moreover, other embodiments may include determining one or more teams of individuals that are suited to the assignment. In some such embodiments, the computing system 250 may determine a plurality of such teams and rank the teams in suitability order.

For example, the user 260 may indicate a need for a French-speaking culinary specialist by selecting the 92G MOS attribute and the French-speaker attribute as suitability criteria. In this example, SGT Smith, SPC Phillips, and MSG Black all lack at least one of the attributes indicated as suitability criteria. Notwithstanding, in some embodiments, the computing system 250 may identify a team comprising SGT Smith and SPC Phillips as being suitable. Moreover, if any other combination of individuals would meet the suitability criteria, the computing system 250 may also identify that combination of individuals as a team and rank that team against the team of SGT Smith and SPC Phillips.

Further, the computing system 250 may output a natural language explanation of how an attribute associated with a team member influenced their ranking in determining one or more suitable teams. For example, the computing system 250 may indicate that the 92G MOS was highly favorable to SPC Phillips' being identified as suitable in one or more of the ranked teams.

Moreover, similar principles to those described above may be applied to identify suitable individuals vying for a plurality of assignments. For example, in some embodiments of the present disclosure, the computing system 250 may receive respective suitability criteria for each of a plurality of military operational assignments. In such embodiments, the computing system 250 may determine a plurality of assignment solutions, each assignment solution identifying, for each military operational assignment, a suitable individual. In this regard, the computing system 250 may avoid assigning the same individual to more than one assignment (e.g., if one of the assignments would preclude an individual from taking on another). Accordingly, the computing system 250 may determine which assignment an individual is most suited for, given that recommending the individual for any particular assignment would require that other, potentially less suitable individuals, be recommended for any others. Having determined a plurality of assignment solutions, the computing system 250 may then rank the solutions in suitability order and output a natural language explanation of the ranking.

According to one such example, a user 260 may use the user interface 100 to identify first suitability criteria indicating that a Culinary Specialist (92G) is required and second suitability criteria indicating that a Unit Supply Specialist (92Y) is required. In response, the computing system 250 may identify the following assignment solutions, ranked in suitability order:
Solution 1: {SPC Phillips, SGT Smith}
Solution 2: {SPC Phillips, MSG Black}

The computing system 250 may provide a natural language explanation of how the MBA attribute influenced the rankings. In this example, the MBA attribute associated with SGT Smith caused solution 1 to be ranked higher than solution 2. Additionally or alternatively, the computing device 260 explain (e.g., in response to a query from the user 260) how the rankings would be affected if MSG Black had an MBA, or if MSG Black were to change his MOS to 92G.

In response, the computing system 260 may explain that MSG Black would have been included in a top-ranked solution. In this way, MSG Black may be given insight into concrete ways to improve his likelihood of being selected for different assignments.

The examples above demonstrate how one or more embodiments of the present disclosure may be advantageous over traditional military personnel management practices. For example, one or more embodiments automate the process of labelling and analyzing personnel data, thereby saving significant time and resources compared to traditional methods. Further, many examples are able to consume organizational data already present in disparate sources, use them as expert knowledge, and eliminate the need for duplicate input or secondary machine learning pipelines.

Additionally, by using a large language model, the natural language engine 240 may provide consistent analysis across diverse sets of data, which is something that cannot be performed through interaction with randomly available senior decision-makers having differing, shifting, and subjective analyses and decision rationales. In this regard, particular embodiments enable a deeper level of analysis than traditional methods, as language models can understand context, identify trends, and make associations based on the prompts provided, in a consistent, reliable, and objective way.

Further still, the computing system 260 may be adaptable to various types of data and different requirements. Also, a user 260 is able to select which features the language model should analyze, which may enable more informed and accurate recommendations.

Embodiments may also provide enhanced transparency and control over traditional solutions. For example, the computing system 250 may provide a user interface 100 that allows users to filter data based on labels, select which data are passed to the natural language engine 240, and ask natural language questions. This empowers users with control over which data the analysis engine 230 reasons over, ensuring that only desired features are analyzed. As is understood in the art, traditional vector-based approaches for retrieval-augmented generation are prone to hallucinations, which may be avoided by the techniques described herein.

The labelling, filtering, and grounding processes described herein may also be designed to ensure that fair and ethical criteria are considered. By enabling the user 260 to see and choose which data are passed to the natural language engine 240, the user 260 may be empowered to obtain answers to complex questions without ethical compromises. Further, unlike many existing systems, the computing system 250 described herein may aggregate data into a single location before labeling, thereby easing access to, and analysis of, the data, e.g., by avoiding the need to navigate the various databases 210 in which various records describing the individuals in the organization are warehoused.

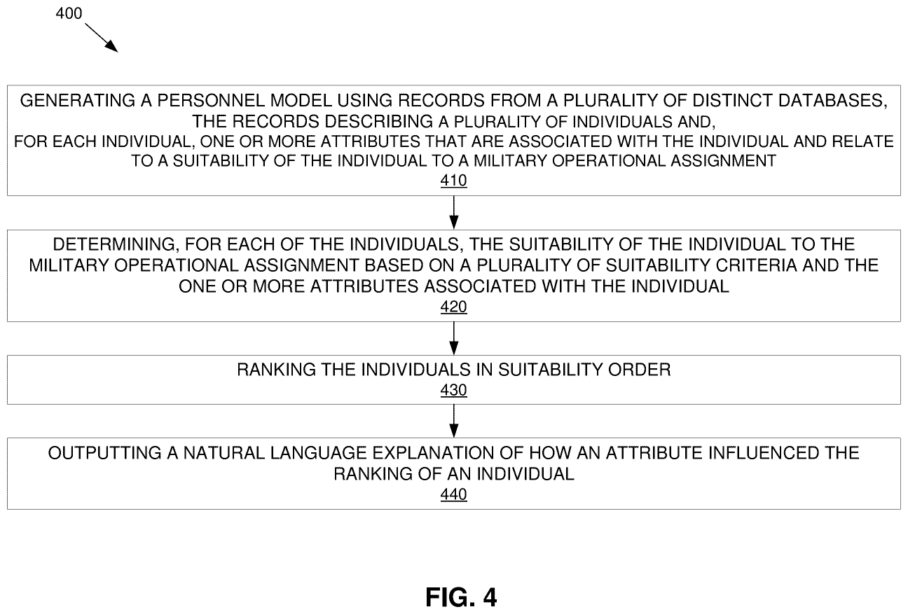

In view of the above, embodiments of the present disclosure include a method 400 performed by a computing system 250, e.g., as illustrated in the example of FIG. 4. The method 400 comprises generating a personnel model using records from a plurality of distinct databases 210 (block 410). The records describe a plurality of individuals. The records further describe, for each individual, one or more attributes that are associated with the individual and relate to a suitability of the individual to a military operational assignment. The method 400 further comprises determining, for each of the individuals, the suitability of the individual to the military operational assignment based on a plurality of suitability criteria and the one or more attributes associated with the individual (block 420). The method further comprises ranking the individuals in suitability order (block 430) and outputting a natural language explanation of how an attribute influenced the ranking of an individual (block 440).

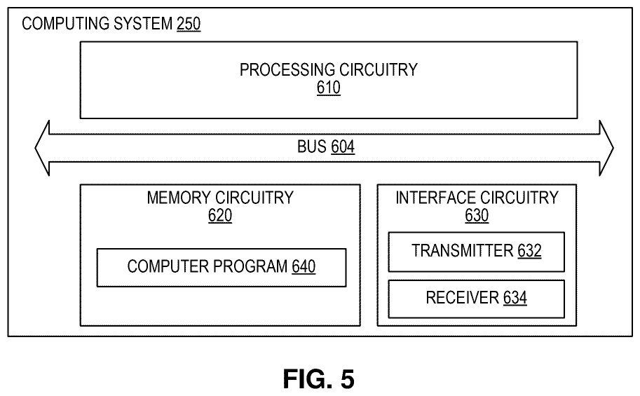

The computing system 250 may be centralized in a single computing device or may be distributed across a plurality of computing devices. An example of such a computing system 250 is illustrated in FIG. 5. According to the example of FIG. 5, the computing system 250 comprises processing circuitry 610, memory circuitry 620, and interface circuitry 630. The processing circuitry 610 is communicatively coupled to the memory circuitry 620 and the interface circuitry 630, e.g., via a bus 604. The processing circuitry 610 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 610 may be programmable hardware capable of executing software instructions stored, e.g., as a machine-readable computer program 640 in the memory circuitry 620.

The memory circuitry 620 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, mini SD card, microSD card, memory stick, thumb-drive, USB flash drive, ROM cartridge, Universal Media Disc), fixed drive (e.g., magnetic hard disk drive), or the like, wholly or in any combination.

The interface circuitry 630 may comprise a controller configured to control data paths interconnecting components of the computing system 250 and/or connecting the computing system 250 to a network. The interface circuitry 630 may be implemented as a unitary physical component, or as a plurality of physical components that are contiguously or separately arranged, any of which may be communicatively coupled to any other or may communicate with any other via the processing circuitry 610. For example, the interface circuitry 630 may comprise a transmitter 632 configured to send communication signals and a receiver 634 configured to receive communication signals, e.g., wirelessly or over a tangible medium.

According to particular embodiments, the processing circuitry 610 is configured to generate a personnel model using records from a plurality of distinct databases. The records describe a plurality of individuals. The records further describe, for each individual, one or more attributes that are associated with the individual and relate to a suitability of the individual to a military operational assignment. The processing circuitry 610 is further configured to determine, for each of the individuals, the suitability of the individual to the military operational assignment based on a plurality of suitability criteria and the one or more attributes associated with the individual. The processing circuitry 610 is further configured to rank the individuals in suitability order and output a natural language explanation of how an attribute influenced the ranking of an individual. The processing circuitry 610 may be so configured by virtue of having the executed the computer program 640 stored in the memory circuitry 620.

Still other embodiments include a computer program 640 comprising instructions that, when executed on processing circuitry 610 of a computing system 250, cause the computing system 250 to carry out the method 400 described above.

Yet other embodiments include a carrier containing the computer program 640. The carrier may be one of an electronic signal, optical signal, radio signal, or computer readable storage medium.

Although the computing system 250 may include the illustrated combination of hardware components, other embodiments may comprise different combinations of components. It is to be understood that these computing devices may comprise any suitable combination of hardware and/or software needed to perform the tasks, features, functions, and methods disclosed herein. While components may be depicted as single boxes within a larger box (or nested within multiple boxes), in practice the devices described herein may comprise multiple different physical components that make up a single illustrated component, and functionality may be partitioned between separate components.

In general, embodiments of the present disclosure may be implemented or performed in other ways than those specifically set forth herein without departing from essential characteristics. The present embodiments are to be considered in all respects as illustrative and not restrictive.

Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

It should also be understood that, although the ordinal terms first, second, etc. may be used herein to describe various elements, these elements are not limited by these ordinal terms. Rather, these ordinal terms are only used to distinguish one element from another. For example, a first element could be termed a second element, and, similarly, a second element could be termed a first element, without departing from the scope of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. Additionally, as used herein, the term “and/or” means any single item or combination of items in the associated list.

It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

What is claimed is:

1. A method, implemented by a computing system, the method comprising:
generating a personnel model using records from a plurality of distinct databases, the records describing:
a plurality of individuals; and
for each individual, one or more attributes that are associated with the individual and relate to a suitability of the individual to a military operational assignment;
determining, for each of the individuals, the suitability of the individual to the military operational assignment based on a plurality of suitability criteria and the one or more attributes associated with the individual;
ranking the individuals in suitability order; and
outputting a natural language explanation of how an attribute influenced the ranking of an individual.

2. The method of claim 1, wherein the natural language explanation comprises an indication that the attribute positively or negatively influenced the ranking of the candidate due to the candidate either being associated or unassociated with the candidate attribute.

3. The method of claim 1, wherein determining the suitability for each of the individuals is responsive to receiving user input that identifies the suitability criteria.

4. The method of claim 1, wherein determining the suitability for each of the individuals is responsive to a change in personnel already assigned to the military operational assignment.

5. The method of claim 1, further comprising outputting a further natural language explanation of one or more actions available to the individual that would improve the ranking upon completion of the one or more actions.

6. The method of claim 1, further comprising determining a team of the individuals that are collectively best suited to the military operational assignment based on the suitability criteria and the attributes associated with the individuals of the team.

7. The method of claim 6, further comprising outputting an indication of whether the individual is on the team of the individuals best suited to the military operational assignment.

8. The method of claim 1, further comprising receiving, from a user, a natural language question that asks for the natural language explanation.

9. The method of claim 1, further comprising:
receiving, from a user, a natural language question asking for a list of individuals suitable for the assignment, wherein determining the suitability of at least one of the individuals is responsive to receiving the natural language question; and
outputting at least part of the ranking in response to the natural language question.

10. The method of claim 1, further comprising identifying one or more unsuitable individuals that do not meet the suitability criteria and, in response, omitting the unsuitable individuals from the ranking.

11. The method of claim 1, wherein:
the suitability criteria comprises a plurality of user-selected attributes;
the method further comprises determining a non-user-selected attribute based on the plurality of user-selected attributes;
ranking the individuals comprises ranking a first individual associated with the non-user-selected attribute higher than a second individual not associated with the non-user-selected attribute.

12. A computing system comprising:
processing circuitry and memory circuitry, the memory circuitry storing instructions executable by the processing circuitry whereby the computing system is configured to:
generate a personnel model using records from a plurality of distinct databases, the records describing:
a plurality of individuals; and
for each individual, one or more attributes that are associated with the individual and relate to a suitability of the individual in performing a military operational assignment;
determine, for each of the individuals, the suitability of the individual to the military operational assignment based on a plurality of suitability criteria and the one or more attributes associated with the individual;
rank the individuals in suitability order; and
output a natural language explanation of how an attribute influenced the ranking of an individual.

13. The computing system of claim 12, wherein the natural language explanation comprises an indication that the attribute positively or negatively influenced the ranking of the candidate due to the candidate either being associated or unassociated with the candidate attribute.

14. The computing system of claim 12, wherein the computing system is configured to determine the suitability for each of the individuals responsive to receiving user input that identifies the suitability criteria.

15. The computing system of claim 12, wherein the computing system is configured to determine the suitability for each of the individuals responsive to a change in personnel already assigned to the military operational assignment.

16. The computing system of claim 12, further configured to output a further natural language explanation of one or more actions available to the individual that would improve the ranking upon completion of the one or more actions.

17. The computing system of claim 12, further configured to determine a team of the individuals that are collectively best suited to the military operational assignment based on the suitability criteria and the attributes associated with the individuals of the team.

18. The computing system of claim 17, further configured to output an indication of whether the individual is on the team of the individuals best suited to the military operational assignment.

19. The computing system of claim 12, further configured to receive, from a user, a natural language question that asks for the natural language explanation.

20. The computing system of claim 12, further configured to:
receive, from a user, a natural language question asking for a list of individuals suitable for the assignment, wherein determining the suitability of at least one of the individuals is responsive to receiving the natural language question; and
output at least part of the ranking in response to the natural language question.

21. The computing system of claim 12, further configured to identify one or more unsuitable individuals that do not meet the suitability criteria and, in response, omit the unsuitable individuals from the ranking.

22. The computing system of claim 12, wherein:
the suitability criteria comprises a plurality of user-selected attributes;
the computing system is further configured to determine a non-user-selected attribute based on the plurality of user-selected attributes;
to rank the individuals, the computing system is configured to rank a first individual associated with the non-user-selected attribute higher than a second individual not associated with the non-user-selected attribute.

23. A non-transitory computer readable medium storing a computer program that, when run on processing circuitry of a programmable computing system, causes the computing system to:
generate a personnel model using records from a plurality of distinct databases, the records describing:
a plurality of individuals; and
for each individual, one or more attributes that are associated with the individual and relate to a suitability of the individual to a military operational assignment;
determine, for each of the individuals, the suitability of the individual to the military operational assignment based on a plurality of suitability criteria and the one or more attributes associated with the individual;
rank the individuals in suitability order; and
output a natural language explanation of how an attribute influenced the ranking of an individual.
